(19) United States
(12) Patent Application Publication
(10) Pub. No.: US 2013/0211918 A1
(43) Pub. Date: Aug. 15, 2013

(54) METHOD AND APPARATUS FOR PROVIDING TARGETED MOBILE ADVERTISEMENT

(71) Applicant: Eun-Jung KWON, Daejeon-si (KR)

(72) Inventor: Eun-Jung KWON, Daejeon-si (KR)

(73) Assignee: Electronics and Telecommunications Research Institute, Daejeon (KR)

(21) Appl. No.: 13/547,868

(22) Filed: Jul. 12, 2012

(30) Foreign Application Priority Data
Feb. 15, 2012 (KR) 1020120015494

(51) Int. Cl. G06Q 30/02

(52) U.S. Cl. 705/14.64

(57) ABSTRACT

A method of providing a targeted advertisement is provided. A mobile terminal receives user characteristic information including information indicating favorite shops and basic information used for user classification, and generates an access control key used for encoding advertisement content by using the received user characteristic information. An advertisement main server selects at least one of shop management servers installed in respective shops by using the user characteristic information, and transmits the user characteristic information to the selected at least one shop management server. The shop management server receiving the user characteristic information encodes advertisement content selected using the user characteristic information with a specific access control key, and broadcasts the encoded advertisement content. The mobile terminal decodes the broadcast advertisement content by using the generated access control key.

### CROSS-REFERENCE TO RELATED APPLICATION

This application claims the benefit under 35 U.S.C. §119(a) of Korean Patent Application No. 10-2012-0015494, filed on Feb. 15, 2012, the entire disclosure of which is incorporated herein by reference for all purposes.

### BACKGROUND

1. Field

The following description relates to a dynamic advertisement access control method for providing a targeted mobile advertisement, and more particularly, to a method and apparatus for providing advertisements containing different contents according to individual characteristics of users of mobile terminals in real time.

2. Description of the Related Art

Mobile advertising has the advantage of enabling personalized advertisements to be provided according to individual characteristics at times designated by a service provider. Also, since mobile terminals are bidirectional media, it is easy to measure user metrics, and therefore, preferences of users exposed to advertisements can be analyzed. For these reasons, many companies, including Apple Inc., have recently integrated wireless communication technologies, such as Bluetooth, Near Field communication (NFC), ZigBee, or Ultra Wide Band (UWB), and IEEE 802.11x wireless Internet, into devices, such as iPhone, iPod, or MacBook.

In order to provide targeted advertisements to these devices, products have been developed for connecting desktop computers, servers or notebooks (for example, iMac, MacBook, or AppleTV) to the wireless Internet and transmitting beacon signals to wireless/wired electronic devices. In addition, smart phones are embedded with various sensor technologies, such as a digital compass, a gravity sensor, an acceleration sensor, or the like. When an iPhone camera is aimed at a street, advertisements containing coupons or contents are displayed on a screen. Therefore, advertisements combined with games, augmented reality or SNS components, capable of sharing contents by interworking with a social network service (SNS) such as a twitter, have emerged.

Most of these new services are provided based on bidirectional communication between advertisement transmission servers and mobile terminals. Several methods of transmitting targeted advertisement contents to mobile terminals have been provided. However, since these services are based on bidirectional communication in wireless network environments, advertisement platforms have tended to be developed in a structure that can transmit advertisement contents or the like by a request from users of mobile terminals, without considering the efficiency of an uplink bandwidth directed from mobile terminals to access points.

A conventional method of providing a mobile advertisement employs a method in which a server individually transmitting an advertisement with reference to personalized information pushes contents, or a mobile terminal periodically polls contents through an access point. In the case of transmitting contents by pushing, assuming that ten mobile terminals having different characteristics are connected through an access point, it is necessary to perform pushing ten times for each of the mobile terminals. This method is not efficient in a wireless network having a low bandwidth compared to a wired communication, and a delay time for reception of contents also increases when more mobile terminals are connected to the access point. In the case of polling, the mobile terminal needs to maintain communication with the server periodically transmitting advertisements. When a plurality of mobile terminals are connected to an access point, data throughput will be reduced.

### SUMMARY

The following description relates to technology for providing a targeted mobile advertisement, in which advertisement contents are broadcast to mobile terminals connected through an access point of a shop, and each of the mobile terminals receives the broadcast advertisement contents and executes a different advertisement, in real time, according to individual characteristics of users of the mobile terminals.

In one general aspect, a method of providing a targeted advertisement includes: receiving, by a mobile terminal, user characteristic information including information indicating favorite shops and basic information used for user classification, and generating an access control key used for encoding advertisement content by using the received user characteristic information; selecting, by an advertisement main server, at least one of shop management servers installed in respective shops by using the user characteristic information, and transmitting the user characteristic information to the selected at least one shop management server; encoding, by the shop management server receiving the user characteristic information, advertisement content selected using the user characteristic information with a specific access control key, and broadcasting the encoded advertisement content; and decoding, by the mobile terminal, the broadcast advertisement content by using the generated access control key.

In another aspect, a mobile terminal includes: a control unit configured to generate an access control key used for decoding advertisement content by using user characteristic information, including information indicating favorite shops and basic information used for user classification, and decode advertisement content broadcast by a shop management server, which manages favorite shops, by using the access control key; and a communication unit configured to transmit the user characteristic information to an advertisement main server managing the shop management server, and receive the broadcast advertisement content.

In yet another aspect, a shop management server includes: a communication unit configured to receive user characteristic information from an advertisement main server, the user characteristic information including information indicating favorite shops and basic information used for user classification; and an advertisement content management unit configured to select advertisement content by using the user characteristic information, and encode the selected advertisement content with a specific access control key related to the user characteristic information, wherein the communication unit broadcasts the encoded advertisement content.

Other features and aspects will be apparent from the following detailed description, the drawings, and the claims.

### BRIEF DESCRIPTION OF THE DRAWINGS

FIG. 1 is a diagram illustrating a system configuration for dynamic access control for providing a targeted mobile advertisement according to an embodiment of the present invention.

FIG. 2 is a diagram illustrating a method of providing a targeted mobile advertisement according to an embodiment of the present invention.

FIG. 3 is a diagram illustrating a screen capable of receiving a user input to select favorite shops according to an embodiment of the present invention.

FIG. 4 is a diagram illustrating a structure of a file system for advertisement content existing in a shop management server according to an embodiment of the present invention.

FIG. 5 is a diagram illustrating a configuration of a DSM-CC data carousel including encoded advertisement content according to an embodiment of the present invention.

FIG. 6 is a diagram illustrating a structure of a DII message included in the DSM-CC data carousel of FIG. 5 according to an embodiment of the present invention.

FIG. 7 is a diagram illustrating a structure of a DDB message included in the DSM-CC data carousel of FIG. 5 according to an embodiment of the present invention.

FIG. 8 is a diagram illustrating an example of a configuration of a mobile terminal according to an embodiment of the present invention.

FIG. 9 is a diagram illustrating an example of a configuration of an advertisement main server according to an embodiment of the present invention.

FIG. 10 is a diagram illustrating an example of a configuration of a shop management server according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

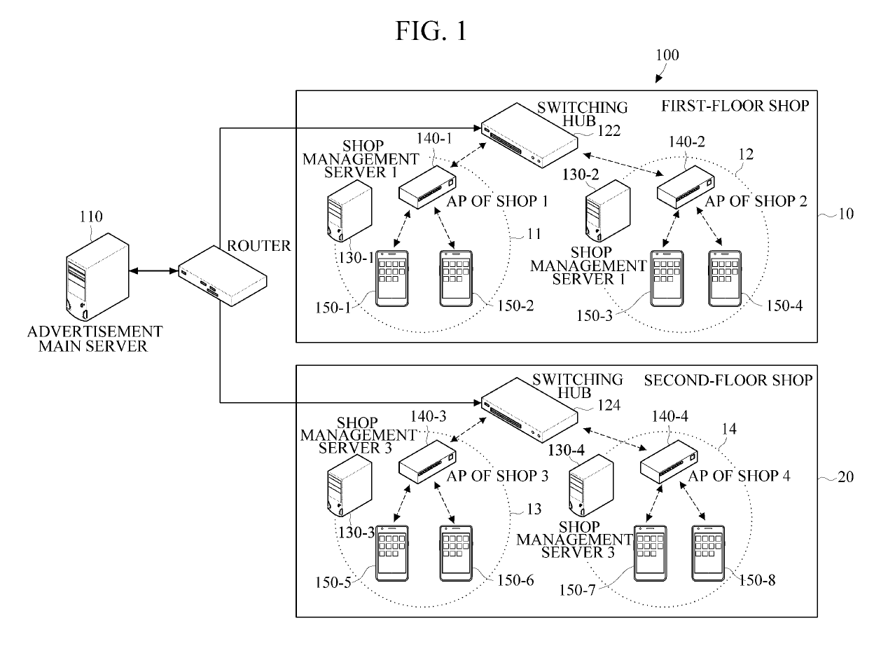

FIG. 1 is a diagram illustrating a system configuration for dynamic access control for providing a targeted mobile advertisement according to an embodiment of the present invention.

The system 100 for the dynamic access control for providing the targeted mobile advertisement may be installed in a department store, a shopping mall, or the like. It will be assumed that the system 100 of FIG. 1 is installed in a department store having a first-floor shop 10 and a second-floor shop 20, the first-floor shop 10 has a first shop 11 and a second shop 12, and the second-floor shop 20 has a third shop 13 and a fourth shop 14. The system 100 may be extended according to the number of floors and the number of shops.

The system 100 includes an advertisement main server 110, shop management servers 130-1, 130-2, 130-3 and 130-4, switching hubs 122 and 124, and access points (APs) 140-1, 140-2, 140-3 and 140-4 installed in the respective shops. One or more mobile terminals 150-1, 150-2, . . . , 150-8 are located in the respective shops 11, 12, 13 and 14 and may receive targeted advertisements.

The advertisement main server 110 manages the entire system 100 so as to provide targeted mobile advertisements. The advertisement main server 110 stores customer information, favorite shop information of each customer, and network information of each shop. When shop information and customer information managed in the advertisement main server 110 are changed, the advertisement main server 110 informs the shop management server installed in the relevant shop that the shop information and the customer information have been changed. The network information stored in the advertisement main server 110 includes information on the access points 140-1, 140-2, 140-3 and 140-4 installed in the respective shops of the department store.

The shop management servers 140-1, 140-2, 140-3 and 140-4 are servers that broadcast advertisement contents about products sold in the shops to the mobile terminals connected through the access points. The shop management servers 140-1, 140-2, 140-3 and 140-4 store contents that are currently used for advertisements in the shops.

The mobile terminal 150-1 is a terminal that supports a wireless connection function to receive advertisement contents transmitted from the respective shops.

The switching hubs 122 and 124 support communication between the advertisement main server 10 and the shop management servers 130-1, 130-2, 130-3 and 130-4. Although the switching hubs 122 and 124 are illustrated as being installed at the respective floors, the switching hubs 122 and 124 may also be installed at various positions according to the structure of buildings.

For convenience, the following description will focus on an operation when the mobile terminal 150-1 receives the targeted advertisement through the first shop management server 130-1 in the first shop 11 of the first floor.

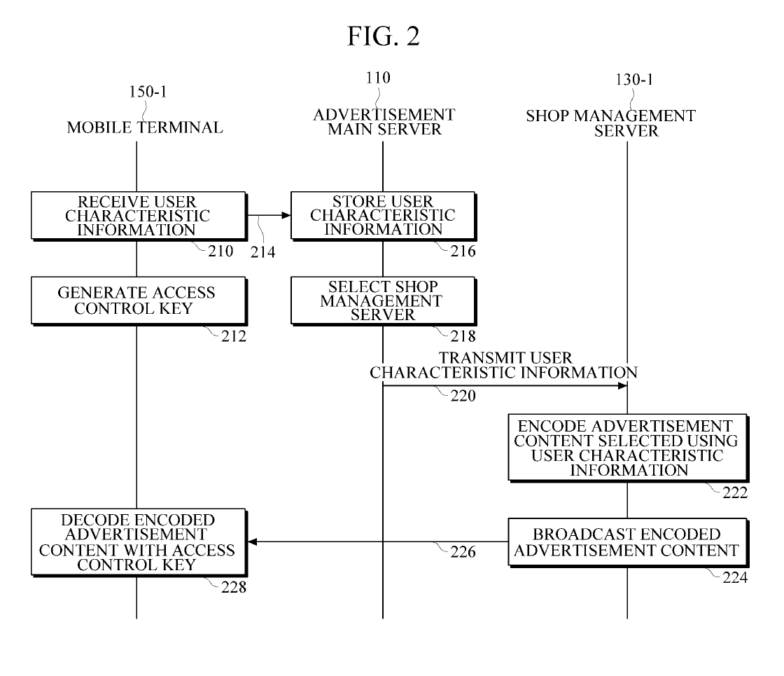

FIG. 2 is a diagram illustrating a method of providing a targeted mobile advertisement according to an embodiment of the present invention.

The mobile terminal 150-1 receives and stores user characteristic information (210). The mobile terminal 150-1 may receive the user characteristic information by executing an application dedicated to a department store that operates to provide the targeted mobile advertisement.

The user characteristic information is used for grouping a plurality of users and classifying appropriate advertisement contents according to the users of each group. The user characteristic information may include information indicating favorite shops and basic information used for user classification. The information indicating favorite shops may include at least one of information specifying favorite shops and information indicating favorite goods. The basic information may include a variety of information, such as a user's age, gender, or the like. Hereinafter, for convenience of description, it will be assumed that the information indicating favorite shops includes favorite shop IDs, and the user characteristic information includes favorite shop IDs and information on a user's gender and age group.

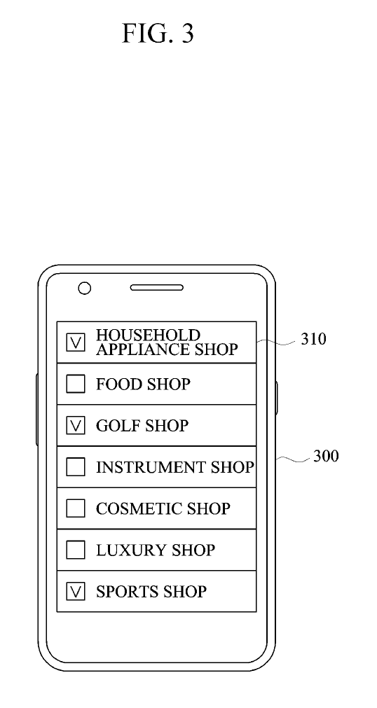

The mobile terminal 150-1 may provide a user input screen for receiving the user characteristic information and may operate to receive the basic user information. For example, the mobile terminal 150-1 may provide a screen as illustrated in FIG. 3 and receive information indicating favorite shops.

FIG. 3 is a diagram illustrating a screen capable of receiving a user input to select favorite shops according to an embodiment of the present invention.

As illustrated in FIG. 3, the mobile terminal 150-1 may provide a user with a list of shops of a department store. As illustrated in FIG. 3, the user of the mobile terminal 150-1 may select favorite shops (for example, a household appliance shop, a golf shop, and a sports shop) from the list of shops of the department store.

Referring again to FIG. 2, the mobile terminal 150-1 generates an access control key (ad access key) capable of receiving a targeted advertisement by using the user characteristic information (212). The access control key may be generated by applying a symmetric key based algorithm, such as Advanced Encryption Standard (AES) or Triple Data Encryption Standard (3DES), to an input value including, for example, a favorite shop ID, gender information, and age group information. In this case, the generated access control key enables the advertisement content transmitted from each shop to be executed in the mobile terminal 150-1, and is symmetric with a key (access control key for encoding) used when the content is encoded in each shop management server according to a user's characteristics.

The mobile terminal 150-1 transmits the user characteristic information to the advertisement main server 110 (214).

The advertisement main server 110 selects the shop management server managing favorite shops by using the received user characteristic information (216). Assuming that the shop management server 130-1 is selected, the advertisement main server 110 transmits the user characteristic information to the shop management server 130-1 (218).

Meanwhile, using the user characteristic information received from the mobile terminal 150-1, the advertisement main server 110 may search network information managing the favorite shops selected by the user, and transmit the searched network information to the mobile terminal 150-1. The network information of each shop may include access point information including, for example, an access point name, an IP address, a MAC address, or the like. Using the received access point information, the mobile terminal 150-1 may analyze a signal from an adjacent access point according to a user's movement. When the signal is a signal from the access point of the favorite shop, the mobile terminal 150-1 may access the corresponding access point. Therefore, when the user moves to the corresponding shop, the mobile terminal 150-1 may be automatically connect to the access point of the corresponding shop, without the user setting the network.

The shop management server 130-1 selects advertisement content suitable for the user of the mobile terminal 150-1 by using the user characteristic information, and encodes the advertisement content selected by using the user characteristic information (222). Specifically, the shop management server 130-1 may encode the advertisement content by using the same access control key as generated in operation 212 by the mobile terminal 150-1.

The shop management server 130-1 transmits the encoded advertisement content to the mobile terminal 150-1 located in the shop in accordance with a broadcast scheme (224). The shop management server 130 may broadcast the encoded advertisement content in accordance with a DSM-CC data carousel scheme.

The broadcast encoded advertisement content is transmitted to the mobile terminal 150-1 through the access point to which the mobile terminal 150-1 is connected (226). The mobile terminal 150-1 decodes the received advertisement by using the access control key generated and stored therein (228). When the result of the decoding using the access control key is normal, the mobile terminal 150-1 may execute the advertisement.

As such, even though the shop management server 130-1 broadcasts the advertisement content, the mobile terminal 150-1 may provide the favorite advertisement content, which has been registered as favorite shops by the user of the mobile terminal 150-1, according to the user's characteristics (age, gender, and the like), instead of decoding all received advertisement contents.

Even when the running application dedicated to the department store is terminated, the mobile terminal 150-1 may retain the user characteristic information input in operation 210, the access control key stored in operation 212, and the access point information of each selected shop which is stored in operation 222, without any deletion thereof. The user characteristic information, the access control key, and the access point information of each selected shop stored in the mobile terminal 150-1 may be deleted according to the user input signal for deletion of information. Alternatively, when it is detected that the user leaves a relevant area, the mobile terminal 150-1 may delete the user characteristic information, the access control key, and the access point information. Using the application dedicated to the department store, the user may check through the user interface that he or she has left the department store. Alternatively, when generating the access control key, the mobile terminal 150-1 may assign information at a predetermined point in time when the access control key will disappear. Therefore, the mobile terminal 150-1 may automatically delete the access control key at the predetermined point in time or when there is no history during a predetermined period of time.

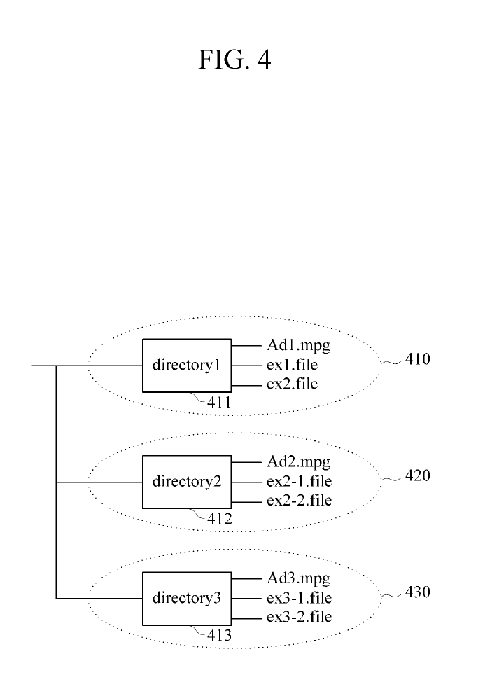

FIG. 4 is a diagram illustrating a file system for the advertisement contents of the shop management server 130-1 according to an embodiment of the present invention.

As illustrated in FIG. 4, the file system for advertisement contents existing in the shop management server 130-1 may include a plurality of directories 411, 421 and 431. For example, files 410 belonging to the first directory 411 may be advertisement files that attract a lot of attention from men in their twenties. Files 420 belonging to the second directory 421 may be advertisement files that attract a lot of attention from women in their twenties. Files 430 belonging to the third directory 431 may be advertisement files that attract a lot of attention from men in their forties.

The number and format of the directories and files included in the shop management server 130-1 are not limited thereto and may be variously modified.

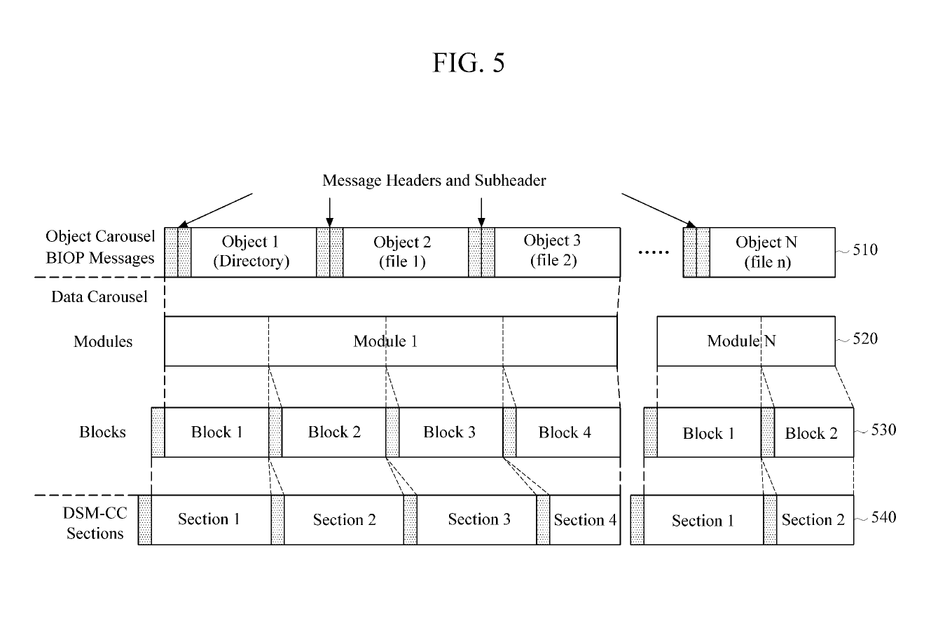

FIG. 5 is a diagram illustrating a configuration of a DSM-CC data carousel including encoded advertisement content according to an embodiment of the present invention.

As described above, the shop management server 130-1 may encode the advertisement content managed therein into a DSM-CC data carousel format, and broadcast the encoded advertisement content to the mobile terminal 150-1 that is currently connected to the access point of the corresponding shop. In addition, the mobile terminal 150-1 may provide the targeted advertisement service by individually accessing broadcast data by using a message access control key generated according to the user characteristic information.

In FIG. 5, in order to transmit a file generated by encoding the advertisement content stored in the shop management server 130-1 by using the access control key generated for each user, the shop management server 130-1 configures an object carousel BIOP message 510 according to a DSM-CC object carousel. The object carousel may be configured with a BIOP directory message including the direction of the file system, and a BIOP file message including the corresponding file. The file system information on the advertisement file stored in the shop management server 130-1 is described in Object 1 (Directory), and file information on actual directory and file may be described in Object 2 (file), Object 3 (file)˜Object N (file n).

The shop management server 130-1 may reconfigure objects of the object carousel BIOP message 510 such that the objects are included in modules as indicated by reference numeral 520, and may reconfigure the modules in a block format as indicated by reference numeral 530. A message reconfigured into the block format is reconfigured into a DSM-CC section format as indicated by reference numeral 540. Data configured with the DSM-CC sections is loaded into a payload of MPEG2-TS or IP data transmitted through a wireless network.

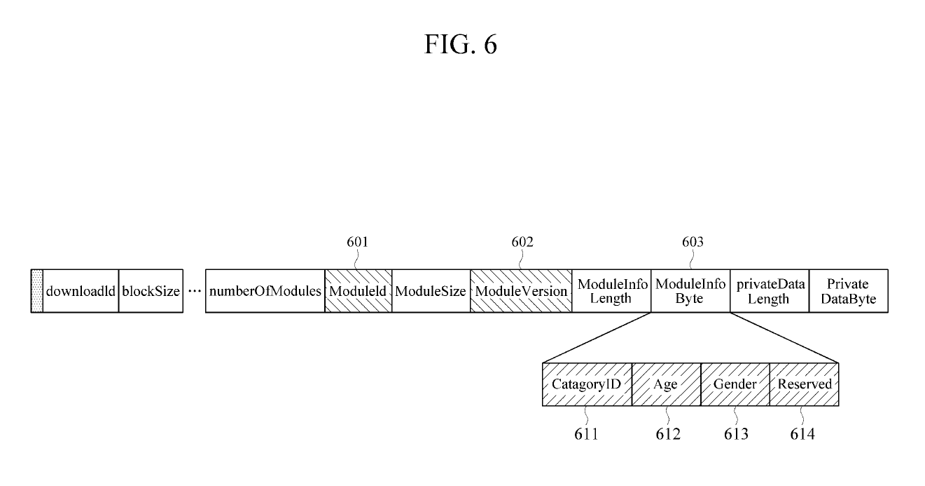

As illustrated in FIG. 6, Object 2 (file), Object 3 (file), . . . , Object N (file n) of the DSM-CC object carousel 501 may include DII (DownloadInfolndication) and DDB (DownloadDataBlock) messages of the DSC-CC data carousel.

FIG. 6 is a diagram illustrating a structure of the DII message included in the DSM-CC data carousel of FIG. 5 according to an embodiment of the present invention.

The DII message contains information on the DDB message related to the number of modules included in the object carousel, module ID, and length. As illustrated in FIG. 6, the DII message may include downloadID, blocksize, numberOfModules, moduleID, moduleSize, moduleVersion, moduleInfoLength, moduleinfoByte, privateDatalength, and PrivateDataByte fields.

The moduleID field 601 indicates identification number of the DII message, and the ModuleVersion field 602 indicates whether the DII message is modified. According to an embodiment, the ModuleVersion field 602 includes version information that is updated with a new value whenever the advertisement directory and file are modified. The ModuleVersion field 602 is version information on the advertisement directory and file. The mobile terminal 150-1 receiving the DII message may know from the version information 602 whether the contents of the advertisement directory and file are changed.

The moduleinfoByte field 603 is information on data contained in the module. According to an embodiment, the moduleinfoByte field 603 includes a CategoryID field 611, an Age field 612, a Gender field 613, and a Reserved field 614.

The CategoryID field 611 includes an ID of a favorite shop selected by the user. The Age field 612 indicates age group of the user of the mobile terminal 150-1. The Gender field 613 indicates the gender of the user of the mobile terminal 150-1.

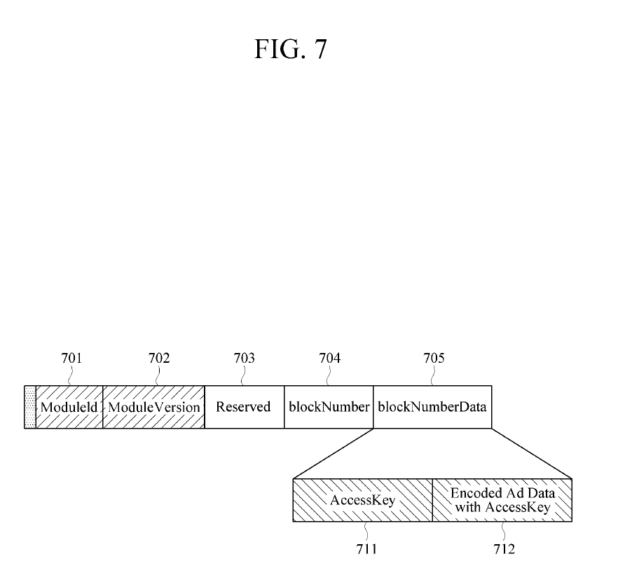

FIG. 7 is a diagram illustrating a structure of the DDB message included in the DSM-CC data carousel of FIG. 5 according to an embodiment of the present invention.

The DDB message is a message containing actual data for generating the module. As illustrated in FIG. 7, the DDB message may include a moduleID field 701, a moduleVersion field 702, a reserved field 703, a blockNumber field 704, and a blockNumberData field 705.

The moduleID field 701 and the moduleVersion field 702 of the DDB message correspond to the moduleID field and the moduleversion field of FIG. 6, respectively. The blockNumberData field 705 includes an AccessKey field 7111 and an Encoded Ad Data With Access Key field 712.

The AccessKey field 711 includes an access control key used for encoding the advertisement content. The AccessKey field 711 may be optionally included. The Encoded Ad Data With Access Key field 712 includes advertisement content generated by encoding advertisement data using the access control key included in the AccessKey field 711.

The mobile terminal 150-1 recognizes the change of the advertisement directory or file whenever the ModuleVersion field 602 of FIG. 6 is changed, and may search the DDB message in which the ModuleID field 701 and the ModuleVersion field 702 identical to the ModuleID field 601 and the ModuleVersion field 602 are defined.

According to an embodiment, when the DII message is searched and the information of the CategoryID field 611, the Age field 612, and the Gender field 613 included in the moduleinfoByte field 603 of the searched DII message is matched with the user characteristic information stored in the mobile terminal 150-1, the mobile terminal 150-1 may search the DDB message in which the ModuleID field 701 and the ModuleVersion field 702 identical to the ModuleID field 601 and the ModuleVersion field 602 of the searched DII message are defined. That is, when values matched with the user characteristic information do not exist in the CategoryID field 603, the Age field 604, and the Gender field 605 of the searched DII message, the mobile terminal 150-1 may not interpret the DDB message in which the ModuleID 701 field and the ModuleVersion field 702 identical to the ModuleID field 601 and the ModuleVersion field 602 of the searched DII message are defined. As such, the mobile terminal 150-1 may determine whether to interpret the DDB message by using the information included in the moduleinfoByte field 603. In this manner, the DDB message containing the advertisement content in which the user of the mobile terminal 150-1 is interested may be filtered.

The mobile terminal 150-1 interprets the searched DDB message by using ModuleID and ModuleVersion information of the DII message containing information matched with the user characteristic information in the moduleinfoByte field 603. The mobile terminal 150-1 may decode the advertisement content included in the Encoded Ad Data With Access Key field 712 of the DDB message by using the generated access control key.

In a case in which the AccessKey field 711 is included in the DDB message, prior to the decoding of the advertisement content, the mobile terminal 150-1 may further perform an operation of determining whether the access control key generated by the mobile terminal 150-1 is identical to the access control key included in the AccessKey field 711. When the access control key generated by the mobile terminal 150-1 is identical to the access control key included in the AccessKey field 711, the mobile terminal 150-1 may decode the advertisement content included in the Encoded Ad Data With Access Key field 712 of the DDB message.

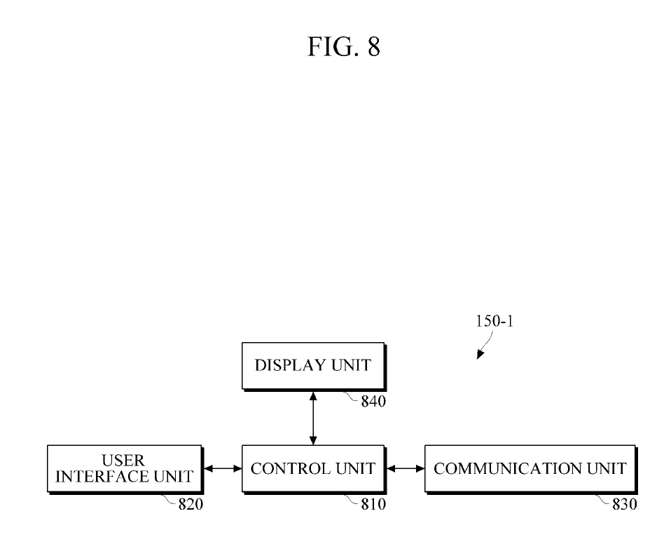

FIG. 8 is a diagram illustrating an example of the configuration of the mobile terminal according to an embodiment of the present invention.

The mobile terminal 150-1 may include a control unit 810, a user interface unit 820, a communication unit 830, and a display unit 840.

The control unit 810 may be configured to control an overall operation of the mobile terminal 150-1. The control unit 810 generates an access control key used for decoding advertisement content by using user characteristic information, including information indicating favorite shops and basic information used for user classification.

The user interface unit 820 receives and transfers a user input signal to the control unit 810. The user interface unit 820 may be configured with a touchpad, a keypad, or the like. The user interface unit 820 receives the user characteristic information, including information indicating favorite shops and basic information used for user classification.

The communication unit 830 communicates with the advertisement main server 110 and the access point installed in each shop. The communication unit 830 receives access point information of the selected shop from the advertisement main server by using the user characteristic information. The communication unit 930 may detect a neighboring wireless signal, connect to the access point transmitting a wireless signal corresponding to the received access point information, and receive the advertisement content broadcast from the access point.

The communication unit 830 transmits the user characteristic information to the advertisement main server managing the shop management server, and receives the broadcast advertisement content. The communication unit 830 receives the DSM-CC data carousel in which the advertisement content encoded with a specific access control key is encoded into the DSM-CC data carousel.

Using the access control key, the control unit 810 decodes the advertisement content broadcast by the shop management server managing favorite shops. Specifically, the control unit 810 may search for the DII message containing the user characteristic information in the DSM-CC data carousel, search for the DDB message containing the module ID and module version information identical to those included the searched DII message, acquire the encoded advertisement content from the DDB message, and decode the encoded advertisement content with the access control key.

In a case in which the DDB message further contains a specific access control key, when the specific access control key is identical to the generated access control key, the control unit 810 may decode the encoded advertisement content with the access control key.

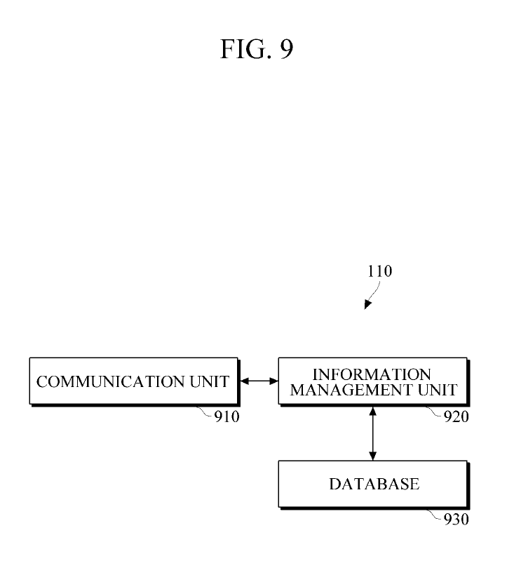

FIG. 9 is a diagram illustrating an example of the configuration of the advertisement main server according to an embodiment of the present invention.

The advertisement main server 110 includes a communication unit 910, an information management unit 920, and a database 930.

The communication unit 910 communicates with communication devices provided within the targeted advertisement system according to the embodiment.

The information management unit 920 manages customer (user) information, information on customer's favorite shops, and network information of each shop. The advertisement main server 110 selects the shop management server managing favorite shops by using the received user characteristic information. The information management unit 920 may transmit the user characteristic information to the selected shop management server through the communication unit 910.

In addition, the information management unit 920 may search for network information managing the favorite shops the user selects by using the user characteristic information received from the mobile terminal, and transmit the searched network information to the mobile terminal. As described above, the network information may include information used for connection to the access point installed in each shop.

The database 920 stores customer (user) information, information on customer's favorite shops, and network information of each shop.

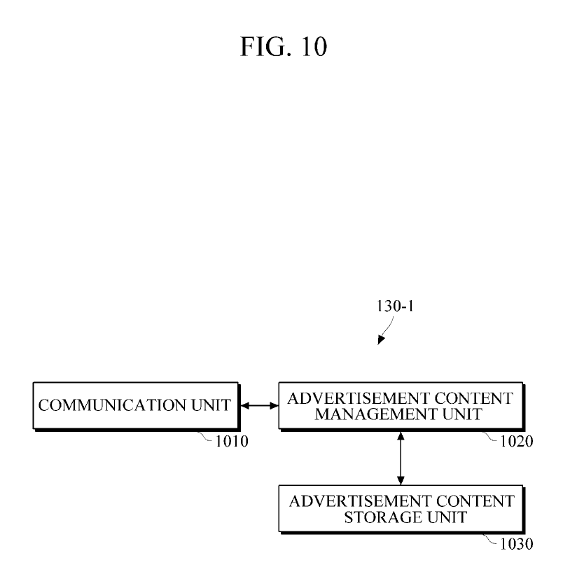

FIG. 10 is a diagram illustrating an example of the configuration of the shop management server according to an embodiment of the present invention.

The shop management server 130-1 may include a communication unit 1010, an advertisement content management unit 1020, and an advertisement content storage unit 1030.

The communication unit 1010 receives the user characteristic information from the advertisement main server 110, wherein the user characteristic information includes information indicating favorite shops and basic information used for user classification.

The advertisement content management unit 1020 may classify advertisement contents by using the user characteristic information, and select advertisement content suitable for the user of the mobile terminal 150-1. The advertisement content management unit 1020 may generate the access control key used for encoding the advertisement content selected using the user characteristic information. The advertisement content management unit 1020 may generate the same access control key as generated by the mobile terminal 150-1 by using the same method as used in the mobile terminal 150-1. The advertisement content management unit 1020 encodes the selected advertisement content by using the generated access control key.

The communication unit 1010 broadcasts the encoded advertisement content. Specifically, the communication unit 1010 encodes the encoded advertisement content into a DSM-CC data carousel and broadcasts the DSM-CC data carousel. As described above, the DSM-CC data carousel may include the DII message containing the user characteristic information, and the DDB message containing the encoded advertisement content.

The content storage unit 1030 stores the advertisement content of the shop managed by the shop management server 130-1. Using the file system as illustrated in FIG. 4, the advertisement contents may be classified and stored according to the user's features or characteristics, such as the user's gender, age, or the like.

According to embodiments of the present invention, advertisement contents are broadcast to mobile terminals connected through an access point of a shop, and the mobile terminals located within the shop receive the broadcast advertisement contents and provide different advertisements, in real time, according to individual characteristics of users of the mobile terminals.

This method can solve the problem of a delay time for reception of contents increasing when mobile terminals connected to an access point perform unicast-based communication in a wireless network having a low bandwidth compared to wired communication. In addition, this method can prevent the users of the mobile terminals from being disturbed by unwanted or inappropriate advertisements when advertisement contents are broadcast to the mobile terminals connected through the access point of the shop. Furthermore, this method can solve the problem that it is necessary for the mobile terminals to maintain communication with the server periodically transmitting advertisements in the case of providing advertisements in accordance with a polling scheme.

Therefore, targeted advertisement contents can be provided while minimizing intervention by the users of the mobile terminals, without transmitting uplink data of the wireless network as possible, if possible, so as to efficiently use a narrow uplink bandwidth in the wireless network. Moreover, advertisers may make a profit due to the mobile advertisements.

The present invention can be implemented as computer-readable codes in a computer-readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. Further, the recording medium may be implemented in the form of carrier waves such as employed in Internet transmission. In addition, the computer-readable recording medium may be distributed to computer systems over a network, in which computer-readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of providing a targeted advertisement, comprising:
receiving, by a mobile terminal, user characteristic information including information indicating favorite shops and basic information used for user classification, and generating an access control key used for encoding advertisement content by using the received user characteristic information;
selecting, by an advertisement main server, at least one of shop management servers installed in respective shops by using the user characteristic information, and transmitting the user characteristic information to the selected at least one shop management server;
encoding, by the shop management server receiving the user characteristic information, advertisement content selected by using the user characteristic information with a specific access control key, and broadcasting the encoded advertisement content; and
decoding, by the mobile terminal, the broadcast advertisement content by using the generated access control key.

2. The method of claim 1, wherein the basic information used for the user classification includes information on user's gender and information on user's age group.

3. The method of claim 1, wherein the information indicating the favorite shops includes at least one of information specifying favorite shops and information indicating favorite goods.

4. The method of claim 1, wherein the specific access control key is identical to the access control key generated in the mobile terminal.

5. The method of claim 1, wherein the shop management server encodes the encoded advertisement content into a DSM-CC data carousel and broadcasts the DSM-CC data carousel.

6. The method of claim 5, wherein the decoding, by the mobile terminal, the broadcast advertisement content by using the generated access control key comprises:
searching for a DII message including the user characteristic information in the DSM-CC data carousel;
searching for a DDB message including the same module ID and module version information as module ID and module version information included in the searched DII message; and
acquiring the encoded advertisement content from the DDB message.

7. The method of claim 6, wherein the DDB message further includes the specific access control key.

8. A mobile terminal comprising:
a control unit configured to generate an access control key used for decoding advertisement content by using user characteristic information, including information indicating favorite shops and basic information used for user classification, and decode advertisement content broadcast by a shop management server, which manages favorite shops, by using the access control key; and
a communication unit configured to transmit the user characteristic information to an advertisement main server managing the shop management server, and receive the broadcast advertisement content.

9. The mobile terminal of claim 8, further comprising a user interface unit configured to receive the user characteristic information, including the information indicating the favorite shops and the basic information used for the user classification.

10. The method of claim 8, wherein the communication unit receives a DSM-CC data carousel including advertisement content encoded with a specific access control key.

11. The method of claim 8, wherein the control unit searches for a DII message including the user characteristic information in the DSM-CC data carousel, searches for a DDB message including module ID and module version information identical to those included the searched DII message, acquires the encoded advertisement content from the DDB message, and decodes the encoded advertisement content with the generated access control key.

12. The mobile terminal of claim 8, wherein when the DDB message further includes a specific access control key that is identical to the generated access control key, the control unit decodes the encoded advertisement content with the generated access control key.

13. The mobile terminal of claim 8, wherein the communication unit receives access point information of a selected shop by using user characteristic information from an advertisement main server, detects a neighboring wireless signal, connects to an access point transmitting a wireless signal corresponding to the received access point information, and receives advertisement content broadcast from the access point.

14. A shop management server comprising:
a communication unit configured to receive user characteristic information from an advertisement main server, the user characteristic information including information indicating favorite shops and basic information used for user classification; and
an advertisement content management unit configured to select advertisement content by using the user characteristic information, and encode the selected advertisement content with a specific access control key related to the user characteristic information,
wherein the communication unit broadcasts the encoded advertisement content.

15. The shop management server of claim 14, wherein the communication unit encodes the encoded advertisement content into a DSM-CC data carousel and broadcasts the DSM-CC data carousel.

16. The shop management server of claim 14, wherein the DSM-CC data carousel includes a DII message containing the user characteristic information and a DDB message containing the encoded advertisement content.

17. The shop management server of claim 14, wherein the specific access control key is identical to an access control key generated in a mobile terminal having the user characteristic information.
